(19) United States
(12) Patent Application Publication
(10) Pub. No.: US 2024/0100908 A1
(43) Pub. Date: Mar. 28, 2024

(54) VEHICLE

(71) Applicant: SUBARU CORPORATION, Tokyo (JP)

(72) Inventors: Ryota NAKAMURA, Tokyo (JP); Tsukasa MIKUNI, Tokyo (JP); Takuya HOMMA, Tokyo (JP); Junichi MOTOYAMA, Tokyo (JP); Kazuhiro HAYAKAWA, Tokyo (JP)

(21) Appl. No.: 18/460,834

(22) Filed: Sep. 5, 2023

(30) Foreign Application Priority Data
Sep. 27, 2022 (JP) 2022-154269

(51) Int. Cl. B60H 1/00; B60Q 3/70

(52) U.S. Cl. CPC B60H 1/00742; B60Q 3/70

(57) ABSTRACT

A vehicle includes an estimator and a control processor. The estimator is configured to perform estimation of an emotion that an occupant has had since before boarding the vehicle. The control processor is configured to make a comprehensive evaluation of a result of the estimation performed by the estimator to determine the emotion, and perform control of an operation mode of an in-vehicle device based on the emotion.

### CROSS-REFERENCE TO RELATED APPLICATIONS

The present application claims priority from Japanese Patent Application No. 2022-154269 filed on Sep. 27, 2022, the entire contents of which are hereby incorporated by reference.

### BACKGROUND

The disclosure relates to a vehicle.

In recent years, systems that comprehensively determine a psychological state (an emotion) of a driver who drives a vehicle, and perform vehicle control based on the result of the determination have been put to practical use.

One example of the above-described technique is disclosed in Japanese Unexamined Patent Application Publication (JP-A) No. 2008-70966. In the technique disclosed in JP-A No. 2008-70966, a psychological state of a driver is comprehensively determined by acquiring information regarding a physical state of the driver using a biological state monitoring part, acquiring an emotional factor that induces an emotion of the driver using an affective factor detection part, and estimating an emotion of the driver based on the physical state of the driver and the emotional factor using an emotion estimation part. In addition, control to issue a notification to the driver is performed by a control content determination part, and the psychological state of the driver is reflected on control of vehicle behaviors. This helps to positively prevent accidents or the like.

Another example of the above-described technique is disclosed in JP-A No. 2019-131147. JP-A No. 2019-131147 discloses a control apparatus that performs traveling control of a vehicle. The control apparatus includes an estimation means for estimating emotions of a plurality of occupants of the vehicle, and a change means for changing a traveling control mode of the vehicle based on results of the estimation of emotions of the occupants by the estimation means.

### SUMMARY

An aspect of the disclosure provides a vehicle including an estimator and a control processor. The estimator is configured to perform estimation of an emotion that an occupant has had since before boarding the vehicle. The control processor is configured to make a comprehensive evaluation of a result of the estimation performed by the estimator to determine the emotion that the occupant has had since before boarding the vehicle, and perform control of an operation mode of an in-vehicle device based on the emotion.

An aspect of the disclosure provides a vehicle including circuitry. The circuitry is configured to perform estimation of an emotion that an occupant has had since before boarding the vehicle, make a comprehensive evaluation of a result of the estimation to determine the emotion that the occupant has had since before boarding the vehicle, and control an operation mode of an in-vehicle device based on the emotion.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a block diagram of a configuration of a vehicle according to one embodiment of the technology.

FIG. 2 is a table illustrating information acquired by respective devices according to one example embodiment of the technology.

FIG. 3 is a table illustrating a relationship between an estimated emotion, a device to be controlled, and the content of control according to one example embodiment of the technology.

FIG. 4 is a flowchart of a process in the vehicle according to one example embodiment of the technology.

FIG. 5 is a block diagram of a configuration of a vehicle according to one example embodiment of the technology.

FIG. 6 is a table illustrating an exemplary database stored in a memory of the vehicle according to one example embodiment of the technology.

FIG. 7 is a flowchart of a process in the vehicle according to one example embodiment of the technology.

### DETAILED DESCRIPTION

According to techniques disclosed in JP-A Nos. 2008-70966 and 2019-131147, vehicle control based on an emotion of a driver who drives a vehicle is performed by associating the emotion of the driver during driving with a driving behavior.

In existing emotion-based vehicle control, an emotion of an occupant is estimated based on only information acquired from an in-vehicle device, as disclosed in JP-A Nos. 2008-70966 and 2019-131147, for example. The existing emotion-based vehicle control thus fails to take into consideration the emotion that the occupant has had since before taking an action to start driving.

However, in the existing emotion-based vehicle control that estimates an occupant's emotion without taking into consideration the emotion that the occupant has had since before taking an action to start driving, a concierge system can remain in a default setting even after the driver boards the vehicle feeling irritated. The driver can feel troublesome with intervention of the concierge system, which changes the emotion for the worse.

It is desirable to provide a vehicle that provides a more comfortable driving environment by alleviating a negative emotion of an occupant even if the occupant has had the negative emotion since before taking an action to start driving.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### First Example Embodiment

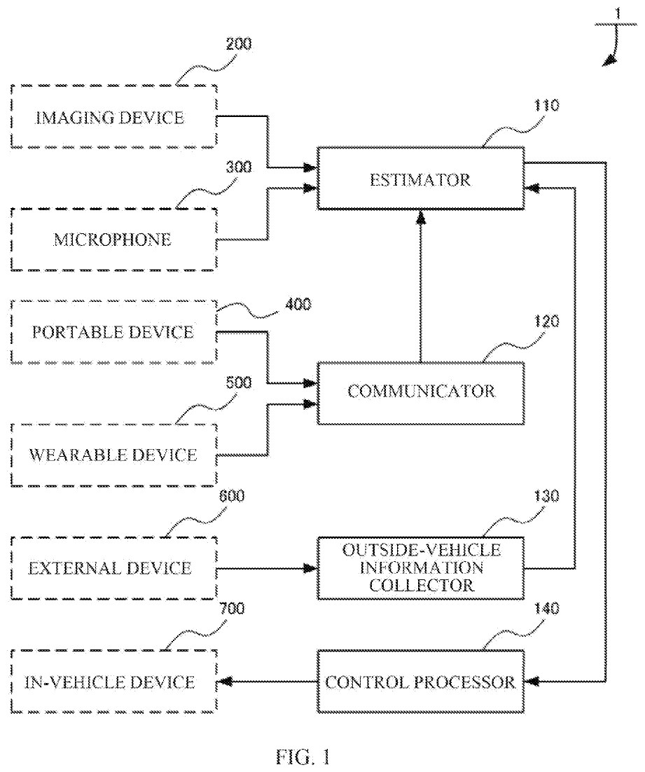

Now, a vehicle 1 according to a first example embodiment is described with reference to FIGS. 1 to 4.

### <Configuration of Vehicle 1>

As illustrated in FIG. 1, the vehicle 1 according to the present example embodiment may include an estimator 110, a communicator 120, an outside-vehicle information collector 130, and a control processor 140.

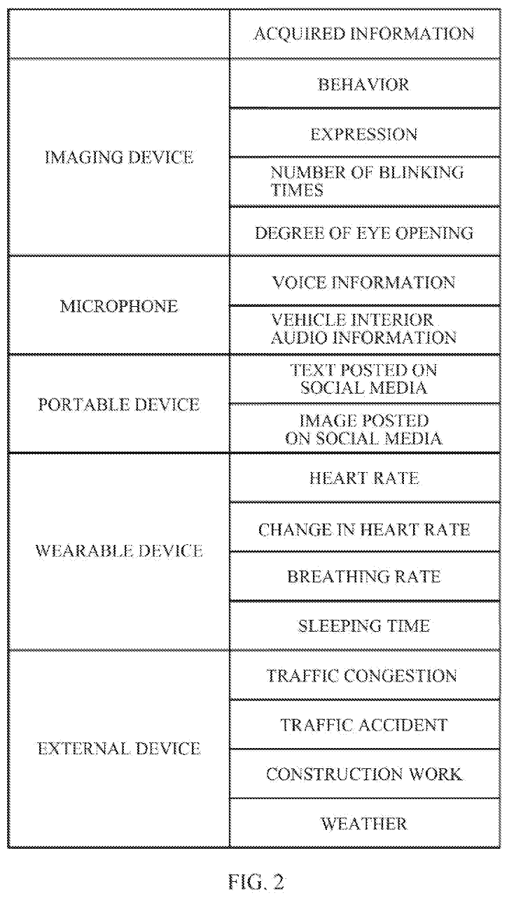

The estimator 110 estimates the emotion that an occupant has had since before boarding the vehicle 1. For example, as illustrated in FIG. 2, the estimator 110 may estimate the emotion that the occupant has had since before boarding the vehicle 1 based on information acquired from respective components of the vehicle 1 including an imaging device 200, a microphone 300, a portable device 400, a wearable device 500, and an external device 600 immediately after boarding of the occupant in the vehicle 1. Examples of the information to be acquired from the imaging device 200 may include image information on a behavior, an expression, the number of blinking times, and the degree of eye opening of the occupant. Examples of the information to be acquired from the microphone 300 may include sound information and vehicle interior audio information. Examples of the information to be acquired from the portable device 400 may include information including the content of text and images posted on social media by the occupant. Examples of the information to be acquired from the wearable device 500 may include information on a heart rate, a change in heart rate, a breathing rate, and a sleeping time of the occupant. Examples of the information to be acquired from the external device 600 may include traffic congestion information, traffic accident information, construction work information, and weather information. In one example, the estimator 110 may individually perform the following estimation processes: a process of estimating the emotion that the occupant has had since before boarding the vehicle 1 based on the information acquired from the imaging device 200 and the microphone 300; a process of estimating the emotion that the occupant has had since before boarding the vehicle 1 based on the information acquired from the portable device 400 or the wearable device 500; and a process of estimating the emotion that the occupant has had since before boarding the vehicle 1 based on the information acquired from the external device 600. The estimator 110 may output respective results of the estimation processes to the control processor 140 to be described later, and the control processor 140 makes a comprehensive evaluation of the results of the estimation processes. The estimator 110 may extract images of various behaviors and expressions from the image information acquired from the imaging device 200. Examples of the images to be extracted may include an image of the occupant in a restless mood, an image of the occupant hitting something, an image of the occupant in a head-forward posture, an image of the occupant in good cheer, an image of the occupant shouting something, an image of the occupant not responding to a question, an image of the occupant with an absent-minded expression, an image of the occupant with an angry expression, an image of the occupant with a smile expression, and an image of the occupant with a grief expression. The estimator 110 may further retrieve relatively recent one from the extracted information, and may estimate the emotion of the occupant based on the retrieved information. The estimator 110 may extract various sounds and voices from the audio information acquired from the microphone 300. Examples of the sounds and voices to be extracted may include an angry voice, a cheerful voice, a sobbing voice, a mournful voice, a voice in good cheer, a shout, a sound of hitting something, a twittering voice, and a sound of thrashing legs. The estimator 110 may further retrieve relatively recent one from the extracted information, and may estimate the emotion of the occupant based on the retrieved information. The estimator 110 may extract various pieces of text and various images from the information acquired from the portable device 400, i.e., the information including the content of the text and images posted on social media by the occupant. Examples of the text and images to be extracted may include text representing joy or anger, text representing a thoughtful mood, text representing joy of communicating with followers, an image of the occupant with a joyful expression, an image of the occupant with an anger expression or an angry action, an image of the occupant in a thoughtful mood, and an image of the occupant playing with friends. The estimator 110 may further retrieve relatively recent one from the extracted information, and may estimate the emotion of the occupant based on the retrieved information. The information acquired from the wearable device 500 and the external device 600 may be qualitative information, and the estimator 110 may thus make a qualitative evaluation of the information acquired from the wearable device 500 and the external device 600 to estimate the emotion of the occupant. In the evaluation, the degree of each piece of the retrieved information may be evaluated. For example, the degree of influence of each piece of the retrieved information on the emotion of the occupant may be scored on a scale of 1 to 5, and the value obtained by simply averaging the scores may be ranked. Alternatively, the degree of influence of each piece of the retrieved information on the emotion of the occupant may be weighted, and the value obtained by averaging the weights may be ranked. Another academically supported calculation expression or evaluation method may be used in the evaluation. Note that the estimator 110 may acquire the information directly from the imaging device 200 and the microphone 300, may acquire the information from the portable device 400 and the wearable device 500 via the communicator 120 to be described later, and may acquire the information from the external device 600 via the outside-vehicle information collector 130 to be described later. Further, the results of the estimation performed by the estimator 110 may be categorized into four emotion types including “delight”, “anger”, “sorrow”, and “pleasure”. However, this is a non-limiting example, and the results of the estimation may be categorized into five or more emotion types.

The communicator 120 may be, for example, a communication module configured to communicate with the portable device 400 and the wearable device 500. The communication may be established using, for example, Wi-Fi (registered trademark) or Bluetooth (registered trademark) that makes it possible to establish communication in a limited area. The communicator 120 may receive social media-related information such as the information including the content of text and images posted on social media by the occupant from the portable device 400, and may receive biological information such as the information on a heart rate, a change in heart rate, a breathing rate, and a sleeping time of the occupant from the wearable device 500. The communicator 120 may send the information received from the portable device 400 and the wearable device 500 to the estimator 110 to be described later.

The outside-vehicle information collector 130 may collect outside-vehicle information such as the traffic congestion information, the traffic accident information, the construction work information, and the weather information from the external device 600. The information collected by the outside-vehicle information collector 130 may be outputted to the estimator 110.

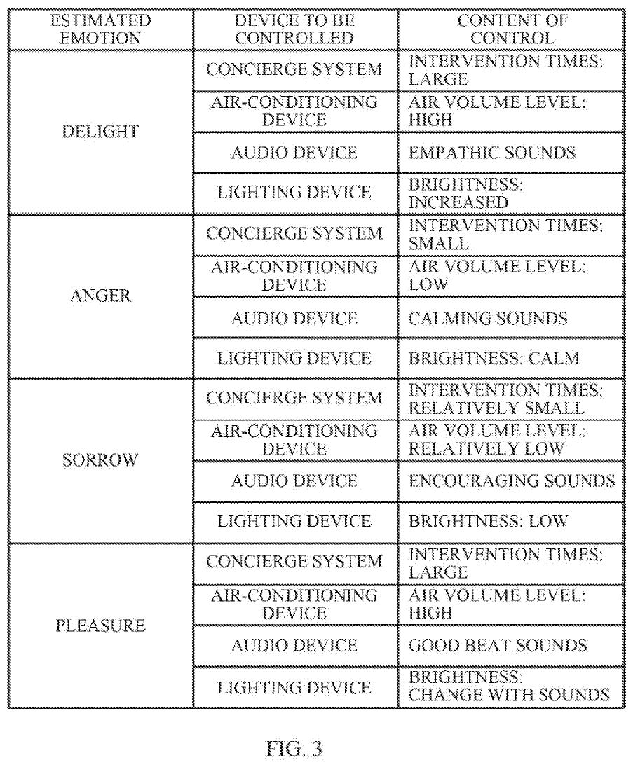

The control processor 140 may control an overall operation of the vehicle 1 based on a control program stored in, for example, a non-illustrated read only memory (ROM). In the present example embodiment, the control processor 140 may make the comprehensive evaluation of the results of estimation by the estimator 110, and may control an operation mode of the in-vehicle device 700 based on the result of the evaluation, i.e., the emotion that the occupant has had since before boarding the vehicle 1. Examples of the in-vehicle device 700 may include, although not limited thereto, a concierge system, an air-conditioning device, an audio device, and a lighting device. As illustrated in FIG. 3, when the result of the comprehensive evaluation is “delight”, the control processor 140 may increase the number of times of interventions of the concierge system, switch the air volume level of the air-conditioning device to a high level, cause the audio device to output sounds that the occupant feels empathy with, and increase the brightness of the lighting device, for example. When the result of the comprehensive evaluation is “anger”, the control processor 140 may reduce the number of times of interventions of the concierge system, switch the air volume level of the air-conditioning device to a low level, cause the audio device to output sounds that calm the occupant's anger, and set the brightness of the lighting device to a level that the occupant feels calm with, for example. When the result of the comprehensive evaluation is “sorrow”, the control processor 140 may slightly reduce the number of times of interventions of the concierge system, switch the air volume level of the air-conditioning device to a relatively low level, cause the audio device to output sounds that the occupant feels encouraged by, and set the brightness of the lighting device to a low level, for example. When the result of the comprehensive evaluation is “pleasure”, the control processor 140 may increase the number of times of interventions of the concierge system than usual, switch the air volume level of the air-conditioning device to the high level, cause the audio device to output sounds with a good beat, and change the brightness of the lightning device in accordance with the sounds.

### <Process in Vehicle 1>

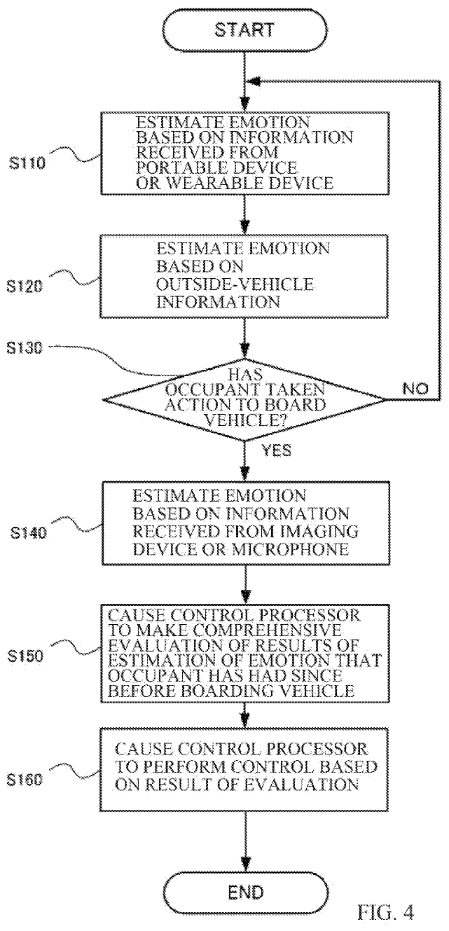

Now, a process in the vehicle 1 according to the first example embodiment is described with reference to FIG. 4.

As illustrated in FIG. 4, the estimator 110 may estimate the emotion that the occupant has had since before boarding the vehicle 1 based on the information acquired from the portable device 400 or the wearable device 500 (Step S110). The estimator 110 may output the result of the estimation to the control processor 140.

The estimator 110 may estimate the emotion that the occupant has had since before boarding the vehicle 1 based on the outside-vehicle information received from the external device 600 (Step S120). The estimator 110 may output the result of the estimation to the control processor 140.

The control processor 140 may determine whether the occupant has already taken an action to board the vehicle 1 based on, for example, the image information (Step S130). When the control processor 140 determines that the occupant has not taken the action to board the vehicle 1 yet based on, for example, the image information (Step S130: NO), the process may return to Step S110.

In contrast, when the control processor 140 determines that the occupant has already taken the action to board the vehicle 1 based on, for example, the image information (Step S130: YES), the estimator 110 may estimate the emotion that the occupant has had since before boarding the vehicle 1 based on the information acquired from the imaging device 200 or the microphone 300 (Step S140). The estimator 110 may output the result of the estimation to the control processor 140.

The control processor 140 may make the comprehensive evaluation of the results of the estimation received from the estimator 110 (Step S150).

The control processor 140 may then control the in-vehicle device 700 based on the result of the comprehensive evaluation (Step S160). Thereafter, the process may end.

### <Workings and Effects>

As described above, the estimator 110 of the vehicle 1 according to the present example embodiment estimates the emotion that the occupant has had since before boarding the vehicle 1. In one example, the estimator 110 may estimate the emotion that the occupant has had since before boarding the vehicle 1 based on, for example, the image information acquired from the imaging device 200 immediately after the boarding of the occupant in the vehicle 1, or the sound information regarding the occupant and the vehicle interior audio information acquired from the microphone 300 immediately after the boarding of the occupant in the vehicle 1. That is, the estimator 110 makes it possible to acquire the information on behaviors, expressions, and voices of the occupant that represent emotions of the occupant, and appropriately estimate the emotion that the occupant has had since before boarding the vehicle 1 based on these pieces of information. Accordingly, even if it is estimated that the occupant has felt irritated since before boarding the vehicle 1, for example, it is possible to effectively prevent the emotion of the occupant from changing for the worse. Further, the control processor 140 controls the operation mode of the in-vehicle device 700 based on the emotion of the occupant determined through the comprehensive evaluation, i.e., the emotion that the occupant has had since before boarding the vehicle 1. For example, the control processor 140 may appropriately control the operation mode of the in-vehicle device 700, such as the concierge system, the air-conditioning device, the audio device, or the lightening device, based on the emotion of the occupant determined through the comprehensive evaluation, i.e., the emotion that the occupant has had since before boarding the vehicle 1. Accordingly, even if the occupant has had a negative emotion since before taking an action to start driving, the negative emotion is alleviated by appropriately controlling the operation mode of the in-vehicle device 700 based on the results of the estimation by the estimator 110. It is therefore possible to provide a more comfortable driving environment.

The estimator 110 of the vehicle 1 according to the present example embodiment may further estimate the emotion that the occupant has had since before boarding the vehicle 1 based on the information acquired from the portable device 400 or the wearable device 500 via the communicator 120. For example, the estimator 110 may estimate the emotion that the occupant has had since before boarding the vehicle 1 based on the information received from the portable device 400, i.e., the information including the content of text and images posted on social media by the occupant, and the biological information on the occupant received from the wearable device 500. That is, the estimator 110 makes it possible to acquire, for example, the information including the content of text and images posted on social media and the biological information that represent emotions of the occupant, and appropriately estimate the emotion that the occupant has had since before boarding the vehicle 1 based on these pieces of information. Accordingly, even if it is estimated that the occupant has had a negative emotion since before boarding the vehicle 1, it is possible to alleviate the negative emotion by appropriately controlling the operation mode of the in-vehicle device 700 based on the result of the estimation by the estimator 110. It is therefore possible to provide a more comfortable driving environment.

The estimator 110 of the vehicle 1 according to the present example embodiment may further estimate the emotion that the occupant has had since before boarding the vehicle 1 based on the outside-vehicle information collected by the outside-vehicle information collector 130. For example, the estimator 110 may estimate the emotion that the occupant has had since before boarding the vehicle 1 based on, for example, the traffic congestion information, the traffic accident information, the construction work information, and the weather information acquired from the external device 600. That is, the estimator 110 makes it possible to acquire, for example, negative information including the traffic congestion information, the traffic accident information, and the construction work information, and the weather information that influence emotions of the occupant, and appropriately estimate the emotion that the occupant has had since before boarding the vehicle 1 based on the information. Accordingly, even if it is estimated that the occupant has had a negative emotion since before boarding the vehicle 1, it is possible to alleviate the negative emotion by appropriately controlling the operation mode of the in-vehicle device 700 based on the result of the estimation by the estimator 110. It is therefore possible to provide a more comfortable driving environment.

### Modification Example 1

In the foregoing example embodiment, the estimator 110 estimates the emotion that the occupant has had since before boarding the vehicle 1. However, the rise and fall of emotions of the occupant in a recent week or so may be estimated, and estimation may be made as to whether the emotion that the occupant has had since before boarding the vehicle 1 is in a good mood, a flat mood, or a bad mood. Making such estimation enables the control processor 140 to perform more accurate and more appropriate control. It is therefore possible to provide a more comfortable driving environment.

### Second Example Embodiment

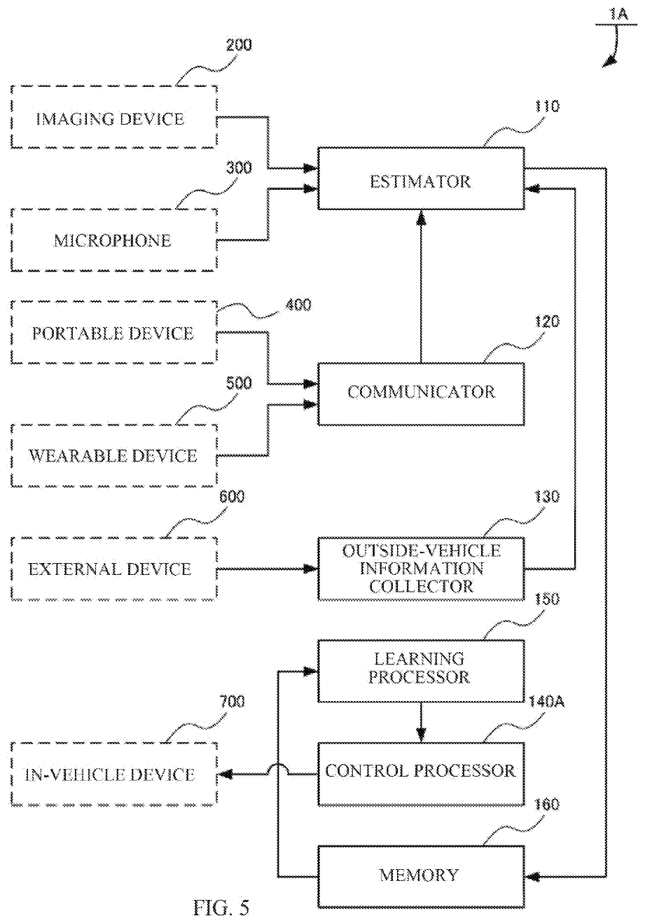

Now, a vehicle 1A according to a second example embodiment is described with reference to FIGS. 5 to 7.

### <Configuration of Vehicle 1A>

As illustrated in FIG. 5, the vehicle 1A according to the present example embodiment may include the estimator 110, the communicator 120, the outside-vehicle information collector 130, a control processor 140A, a learning processor 150, and a memory 160. Note that the components denoted by the same reference numerals as those of the components described in the first example embodiment have similar functions to the components described in the first example embodiment, and detailed description thereof are thus omitted.

The control processor 140A may control an overall operation of the vehicle 1A based on a control program stored in, for example, a non-illustrated read only memory (ROM). In the present example embodiment, the control processor 140A may make the comprehensive evaluation of the results of estimation performed by the estimator 110. The learning processor 150 to be described later may learn all of the results of the comprehensive evaluations made by the control processor 140A and indices of the comprehensive evaluations. The control processor 140A may control the operation mode of the in-vehicle device 700 based on the results of learning by the learning processor 150.

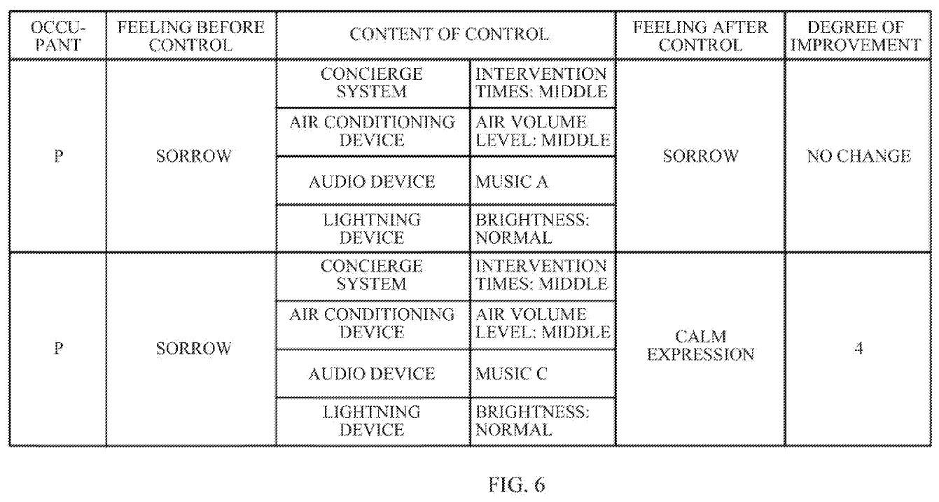

The learning processor 150 may learn all of the results of the comprehensive evaluations made by the control processor 140A, the content of control by the control processor 140A, and an emotional change of the occupant upon the control by the control processor 140A. The learning processor 150 may output the results of learning to the control processor 140A. For example, the learning processor 150 may learn, based on a database stored in the memory 160 to be described later, which control changed which emotion of a specific occupant, and which environment the specific occupant unconsciously preferred to when which emotion the occupant had. In a case where the database stored in the memory 160 is configured as illustrated in FIG. 6 and where the result of the comprehensive evaluation of the emotion of an occupant P by the control processor 140A is “sorrow”, for example, the learning processor 150 may search the database for information regarding the occupant P having an emotion of “sorrow”. The learning processor 150 may then learn, based on the retrieved information, that music C is more favorable to the occupant P than music A is, and may output the result of learning to the control processor 140A.

The memory 160 may store the database in which the result of the comprehensive evaluation regarding a specific occupant made by the control processor 140, the content of the control performed by the control processor 140A based on the result of the comprehensive evaluation, the emotion of the specific occupant estimated by the estimator 110 after the control by the control processor 140A, and the degree of the emotional change of the specific occupant between before and after the control by the control processor 140A are associated with each other.

### <Process in Vehicle 1A>

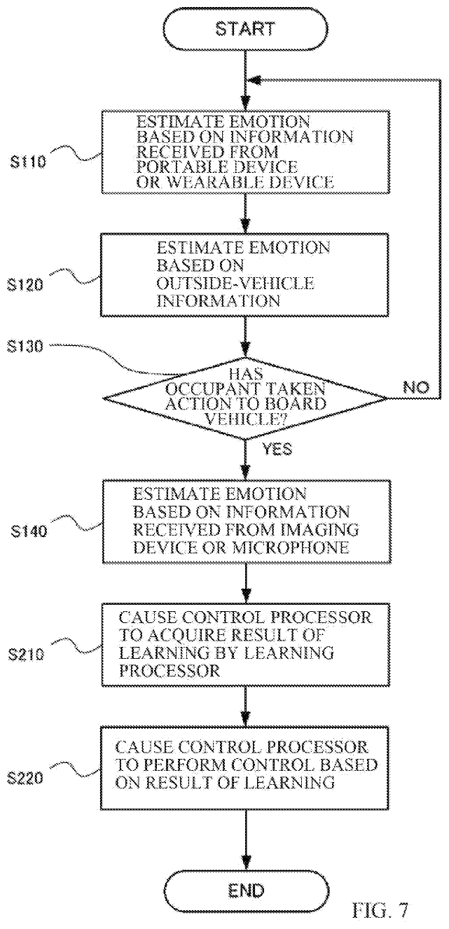

Now, a process in the vehicle 1A according to the second example embodiment is described with reference to FIG. 7.

As illustrated in FIG. 7, the estimator 110 may estimate the emotion that the occupant has had since before boarding the vehicle 1A based on the information acquired from the portable device 400 or the wearable device 500 (Step S110). The estimator 110 may output the result of the estimation to the control processor 140A.

The estimator 110 may estimate the emotion that the occupant has had since before boarding the vehicle 1A based on the information acquired from the external device 600 (Step S120). The estimator 110 may output the result of the estimation to the control processor 140A.

The control processor 140A may determine whether the occupant has already taken an action to board the vehicle 1A based on, for example, the image information (Step S130). When the control processor 140A determines that the occupant has not taken the action to board the vehicle 1A yet based on, for example, the image information (Step S130: NO), the process may return to Step S110.

In contrast, when the control processor 140A determines that the occupant has already taken the action to board the vehicle 1A based on, for example, the image information (Step S130: YES), the estimator 110 may estimate the emotion that the occupant has had since before boarding the vehicle 1A based on the information acquired from the imaging device 200 or the microphone 300 (Step S140). The estimator 110 may output the result of the estimation to the control processor 140A.

The control processor 140A may make the comprehensive evaluation of the results of estimation received from the estimator 110 while acquiring the result of learning by the learning processor 150 (Step S210).

The control processor 140A may then control the in-vehicle device 700 based on the result of learning by the learning processor 150 (Step S220). Thereafter, the process may end.

### <Workings and Effects>

As described above, the control processor 140A in the vehicle 1A according to the present example embodiment makes the comprehensive evaluation of the results of estimation by the estimator 110. The learning processor 150 may learn all of the results of the comprehensive evaluations made by the control processor 140A and the indices of the comprehensive evaluations. The control processor 140A may control the operation mode of the in-vehicle device 700 based on the result of learning by the learning processor 150. For example, the learning processor 150 may perform learning based on the database stored in the memory 160. In the database, all of the results of the comprehensive evaluations made by the control processor 140A, the content of the control performed by the control processor 140A, and the emotional change of the occupant upon the control by the control processor 140A may be associated with each other. The control processor 140A may appropriately control the operation mode of the in-vehicle device 700 such as the concierge system, the air-conditioning device, the audio device, or the lighting device based on the result of learning by the learning processor 150. That is, the control processor 140A may appropriately control the operation mode of the in-vehicle device 700 such as concierge system, the air-conditioning device, the audio device, or the lighting device based on the result of learning of a past data group by the learning processor 150. Accordingly, even if the occupant has had a negative emotion since before taking an action to start driving, it is therefore possible to provide a more comfortable driving environment by alleviating the negative emotion.

### Modification Example 2

In the foregoing example embodiments, the learning processor 150 may learn all of the results of the comprehensive evaluations regarding the specific occupant made by the control processor 140A, the content of the control performed by the control processor 140A, and the emotional change of the occupant upon the control by the control processor 140A, and may output the result of learning to the control processor 140A. However, in a case where there is another occupant (e.g., a sibling) determined to have similar sensitivity based on the information regarding posts on social media, for example, a similar result of learning may be applied to the control. Alternatively, the learning processor 150 may perform learning based on a common database shared between these occupants. Employing such a learning mode makes it possible to reduce a processing load on the learning processor 150 and increase the amount of trained data. It is therefore possible to improve learning accuracy.

Note that it is possible to implement the vehicles 1 and 1A of the example embodiments of the disclosure by recording the processes to be executed by, for example, the estimator 110, the control processors 140 and 140A, and the learning processor 150 on a non-transitory recording medium readable by a computer system, and causing, for example, the estimator 110, the control processors 140 and 140A, and the learning processor 150 to load the programs recorded on the non-transitory recording medium thereon to execute the programs. The computer system as used herein may encompass an operating system (OS) and hardware such as a peripheral device.

In addition, when the computer system utilizes a World Wide Web (WWW) system, the “computer system” may encompass a website providing environment (or a website displaying environment). The program may be transmitted from a computer system that contains the program in a storage device or the like to another computer system via a transmission medium or by a carrier wave in a transmission medium. The “transmission medium” that transmits the program may refer to a medium having a capability to transmit data, including a network (e.g., a communication network) such as the Internet and a communication link (e.g., a communication line) such as a telephone line.

Further, the program may be directed to implement a part of the operation described above. The program may be a so-called differential file (differential program) configured to implement the operation by a combination of a program already recorded on the computer system.

Although some example embodiments of the disclosure have been described in the foregoing by way of example with reference to the accompanying drawings, the disclosure is by no means limited to the embodiments described above. It should be appreciated that modifications and alterations may be made by persons skilled in the art without departing from the scope as defined by the appended claims. The disclosure is intended to include such modifications and alterations in so far as they fall within the scope of the appended claims or the equivalents thereof.

One or more of the estimator 110 and the control processors 140 and 140A in FIGS. 1 and 5 are implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the estimator 110 and the control processors 140 and 140A. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the estimator 110 and the control processors 140 and 140A in FIGS. 1 and 5.

1. A vehicle comprising:
an estimator configured to perform estimation of an emotion that an occupant has had since before boarding the vehicle; and
a control processor configured to
make a comprehensive evaluation of a result of the estimation performed by the estimator to determine the emotion that the occupant has had since before boarding the vehicle, and
perform control of an operation mode of an in-vehicle device based on the emotion.

2. The vehicle according to claim 1, further comprising
a communicator configured to communicate with a portable device or a wearable device associated with the occupant, wherein
the estimator is configured to estimate the emotion based on information acquired by the communicator.

3. The vehicle according to claim 2, wherein
the information comprises information including content of text and images posted on social media by the occupant, and
the estimator is configured to estimate the emotion based on the information including the content of the text and the images posted on the social media by the occupant.

4. The vehicle according to claim 2, further comprising
an outside-vehicle information collector configured to collect outside-vehicle information, wherein
the estimator is configured to estimate the emotion based on the outside-vehicle information collected by the outside-vehicle information collector.

5. The vehicle according to claim 3, further comprising
an outside-vehicle information collector configured to collect outside-vehicle information, wherein
the estimator is configured to estimate the emotion based on the outside-vehicle information collected by the outside-vehicle information collector.

6. The vehicle according to claim 1, further comprising
a learning processor configured to
perform learning all of a result of the comprehensive evaluation made by the control processor, content of the control performed by the control processor, and an emotional change of the occupant upon the control performed by the control processor, and
output a result of the learning to the control processor.

7. A vehicle comprising
circuitry configured to
perform estimation of an emotion that an occupant has had since before boarding the vehicle,
make a comprehensive evaluation of a result of the estimation to determine the emotion that the occupant has had since before boarding the vehicle, and
control an operation mode of an in-vehicle device based on the emotion.
